(19) United States
(12) Patent Application Publication
(10) Pub. No.: US 2008/0317471 A1
(43) Pub. Date: Dec. 25, 2008

(54) APPARATUS AND SYSTEM FOR REMOTE CONTROL

(75) Inventor: KUN-I YUAN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/945,521

(22) Filed: Nov. 27, 2007

(30) Foreign Application Priority Data
Jun. 20, 2007 (CN) 200710200839.X

(51) Int. Cl. H04B 10/00

(52) U.S. Cl. 398/106

(57) ABSTRACT

An exemplary remote control apparatus includes a light source, a control module, an image sensing module, an image processing module and a communication module. The control module is separated from the light source, moveable by a user, and configured for receiving light beams from the light source in an incident direction and reflecting the light beams in a direction anti-parallel to the incident direction. The image sensing module senses images formed by light beams reflected by the control module. The image processing module processes images sensed by the image sensing module and generates a control signal associated with a movement of the control module imparted by the user. The communication module outputs the control signal to control the information technology system. A remote control system using the remote control apparatus is also provided.

### BACKGROUND

1. Technical Field

The present invention generally relates to input devices for remotely controlling information technology systems and, particularly to a remote control apparatus and a remote control system having the same.

2. Description of Related Art

A mouse is a popular input and control device for information technology systems such as computers, game machines etc. To operate a mouse, a user typically moves the mouse on a planar surface. The mouse senses such movement by mechanical or optical means, and sends a corresponding control signal to the information technology system to concurrently control a cursor displayed by the information technology system. The mouse communicates with the information technology system by a wire or a wireless means.

With a conventional mouse, a movement for controlling an information technology system imparted by a user is typically confined to a two dimensional plane. However, in situations such as three-dimensional game, it is often desirable for the user to be able to concurrently control the cursor by moving the mouse in a three-dimensional manner.

Elsadek et al. have published a paper on 1998 IEEE International Conference on Systems, Man and Cybernetics entitled “New Technique For Investigating Three Dimensional (3D) Mouse” proposing a 3D mouse with which an object's hologram is constructed using rectangular and square microstrip patch antenna and antenna array to store the 3D data information about the object in 2D (two dimensional) media by means of electromagnetic waves. However, by using microstrip antenna and hologram principles the structure of such a 3D mouse is rather complicated with a relatively high manufacturing cost.

Therefore, what is needed is a remote control apparatus that can control the information technology system in a three-dimensional manner, and a remote control system using the same.

### SUMMARY

A remote control apparatus, in accordance with a present embodiment, is provided. The remote control apparatus includes a light source, a control module, an image sensing module, an image processing module, and a communication module. The light source is configured (i.e., structured and arranged) for emitting a light beam in a predetermined wavelength range. The control module is separated from the light source and moveable by the user. The control module is configured for receiving the light beam from the light source in an incident direction and reflecting the incident light beam in a direction anti-parallel to the incident direction. The image sensing module is fixed relative to the light source and configured for sensing an image formed by the reflected light beam. The image processing module is electrically/electronically connected with the image sensing module. The image processing module is configured for processing images sensed by the image sensing module and generating a control signal associated with a movement of the control module in three dimensional space imparted by the user. The communication module is electrically connected with the image processing module and configured for outputting the control signal received from the image processing module to an information technology system.

A remote control system, in accordance with another present embodiment, is provided. The remote control system includes a light source, a control module, an image sensing module, an image processing module, a communication module, and an information technology system. The light source is configured for emitting a light beam in a predetermined wavelength range. The control module is separated from the light source and moveable by a user. The control module is configured for receiving the light beam from the light source in an incident direction and reflecting the incident light beam in a direction anti-parallel to the incident direction. The image sensing module is fixed relative to the light source and configured for sensing an image formed by the reflected light beam. The image processing module is electrically connected with the image sensing module. The image processing module is configured for processing images sensed by the image sensing module and generating a control signal associated with a movement of the control module in three dimensional space imparted by the user. The communication module is electrically connected with the image processing module and configured for outputting the control signal received from the image processing module to the information technology system. The information technology system is subjected to the control of the control signal from the communication module.

### BRIEF DESCRIPTION OF THE DRAWING

Many aspects of the present apparatus and system can be better understood with reference to the following drawings. The components in the drawings are not necessarily drawn to scale, the emphasis instead being placed upon clearly illustrating the principles of the present apparatus and system.

FIG. 1 is a block diagram of an exemplary remote control system, in accordance with a present embodiment.

FIG. 2 is a schematic, cross-sectional view of a control module of the remote control system of FIG. 1.

FIG. 3 is a schematic, cross-sectional view of a control module of a remote control system in accordance with another present embodiment.

FIG. 4 is a schematic, cross-sectional view of a control module of a remote control system in accordance with still another present embodiment.

FIG. 5 is a schematic view of an image sensing module of the remote control system of FIG. 1.

### DETAILED DESCRIPTION OF THE EMBODIMENT

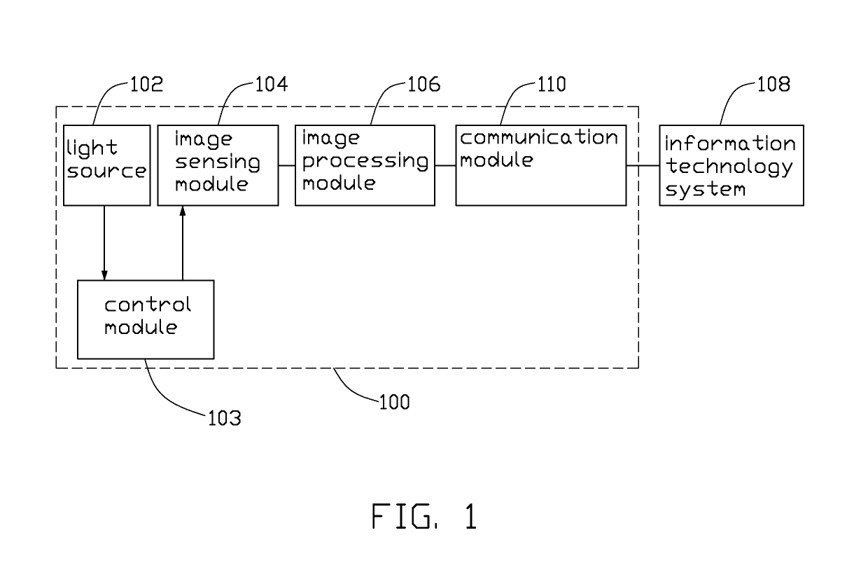

Referring to FIG. 1, a remote control system, in accordance with a present embodiment, is provided. The remote control system includes a remote control apparatus 100 and an information technology system 108. The information technology system 108 is electrically connected with the remote control apparatus 100 and under the control of the remote control apparatus 100. The remote control apparatus 100 includes a light source 102, a control module 103, an image sensing module 104, an image processing module 106 and a communication module 110.

The light source 102 is fixed with respect to the control module 103, which means the light source 102 does not move with the movement of the control module 103 in operation of the remote control system by the user. The light source 102 is configured (i.e., structured and arranged) to emit light in a predetermined wavelength range. The light source 102 beneficially is an infrared light source, such as an infrared LED (light emitting diode).

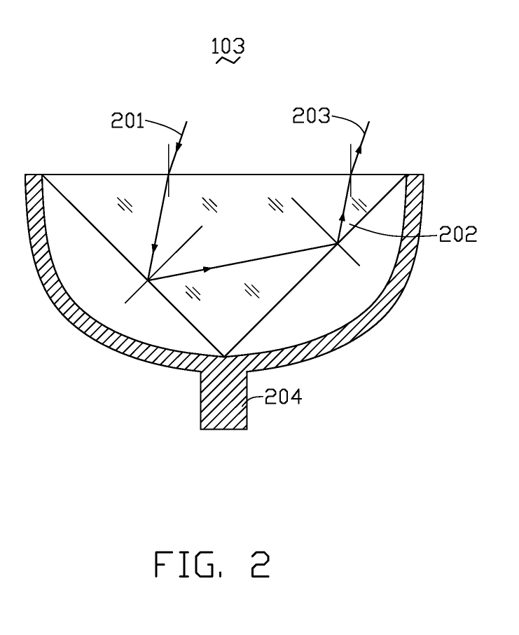

Referring to FIG. 2, the control module 103 is separated from the light source 102. The control module 103 includes an isosceles right triangular prism 202 and a handle member 204. The isosceles right triangular prism 202 is fixedly mounted to the handle member 204. A light beam 201 incident in an incident direction on the isosceles right triangular prism 202, the incident light is reflected by the isosceles right triangular prism 202 twice to form an outgoing light beam 203 in a direction anti-parallel to the incident direction. The handle member 204 is configured for allowing a user to hold the handle member 204 so as to move the control module 103 in three dimensional space.

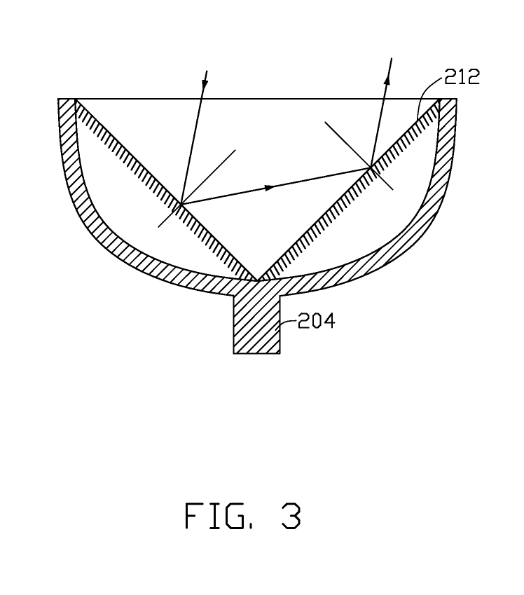

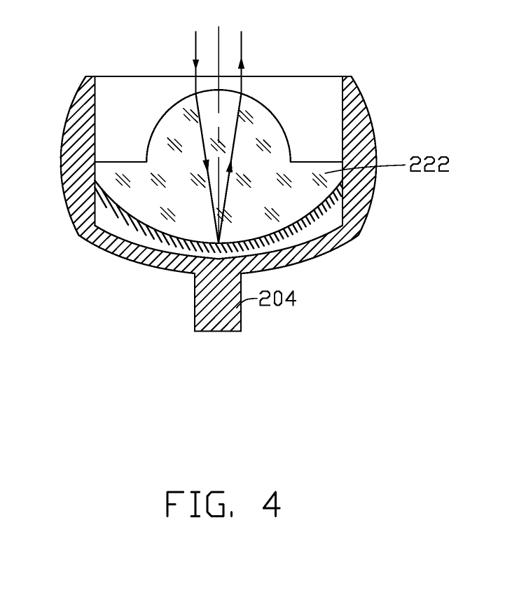

It is understood that the isosceles right triangular prism 202 can be replaced by a mirror assembly 212 as shown in FIG. 3, a cat's eye reflector 222 as shown in FIG. 4, or other optical devices that can reflect an incident light beam in a direction anti-parallel to the incident direction of the incident light beam.

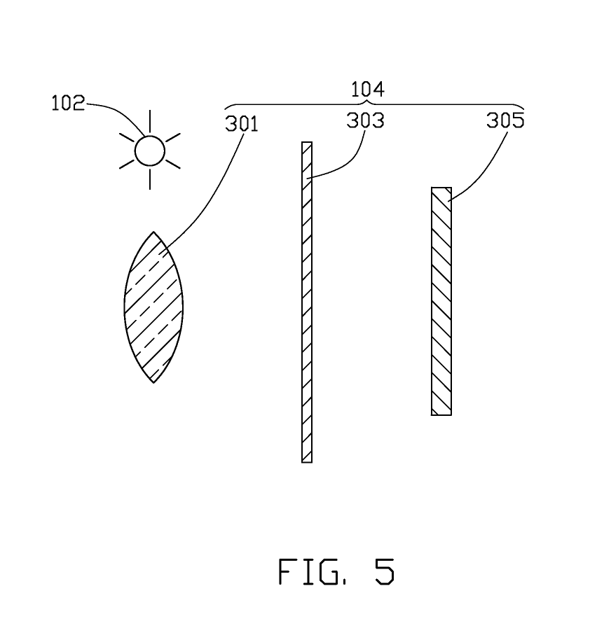

The image sensing module 104 is fixed relative to the light source 102. As illustrated in FIG. 5, the image sensing module 104 includes a lens module 301, a filter 303 and an image sensor 305. The lens module 301 is configured for focusing light incident on the image sensing module 104 into an image on the image sensor 305. The filter 303 is disposed between the lens module 301 and the image sensor 305 and configured for transmitting the light in the wavelength range of the light source 102. The light source 102 beneficially is an infrared light source, and the filter 303 correspondingly is an infrared pass filter, which only transmits the infrared light. Such choice of the light source 102 and the filter 303 can ensure that the image sensor 305 only receives the light incident from the light source 102, not interfered by ambient light outside of the light source 102 wavelength range.

The image processing module 106 is electrically/electronically connected with the image sensing module 104. The image processing module 106 includes a digital signal processor. When a user moves the control module 103 to different locations in three dimensional space, the control module 103 consistently reflects incident light beams in directions anti-parallel to the incident directions of the light beams respectively at all locations. In such movement, the images sensed by the image sensing module 104 are changing based on the specific locations of the control module 103 and the incremental differences between the images associated with the movement. During the movement, the image processing module 106 receives the images sensed by the image sensing module 104 in a predetermined frequency, analyzes the incremental differences between the images, and generates a control signal associated with the movement of the control module in three dimensional space.

The communication module 110 is electrically connected with the image processing module 106 and configured for receiving the control signal from the image processing module 106 and transmitting the control signal to the information technology system 108. The information technology system 108 can be a computer, an electronic game machine, etc. The information technology system 108 is subject to the control of the control signal and generally includes a processing unit (not shown) and a display screen (not shown). The processing unit controls a movement of an object (e.g., a cursor) displayed on the display screen according to the control signal.

In this embodiment, by optical principles and digital signal processing, the command movement of a user imparts to the remote control apparatus 100 so as to control the information technology system 108 not limited in any two-dimensional plane. In other words, the user can control the information technology system 108 by moving the control module 103 of the remote control apparatus 100 in a three-dimensional manner. Such freedom provided by this embodiment allows the user to conveniently utilize the remote control. In addition, the illustrated embodiment does not use relatively complicated microstrip antenna and hologram principles. As a result, it is simple to carry out the remote control and thus, the manufacturing cost of the remote control apparatus 100 is low.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. A remote control apparatus, comprising:
a light source configured for emitting a light beam in a predetermined wavelength range;
a control module separated from the light source and moveable by a user in a command movement, the control module being configured for receiving the light beam from the light source in an incident direction and reflecting the light beam in a direction anti-parallel to the incident direction;
an image sensing module fixed relative to the light source and configured for sensing an image formed by the reflected light beam;
an image processing module electrically connected with the image sensing module, the image processing module being configured for processing images sensed by the image sensing module and generating a control signal associated with a movement of the control module in three dimensional space imparted by the user; and
a communication module electrically connected with the image processing module, the communication module being configured for outputting the control signal received from the image processing module to an information technology system.

2. The remote control apparatus as claimed in claim 1, wherein the control module comprises one of an isosceles right triangular prism, a mirror assembly and a cat's eye reflector.

3. The remote control apparatus as claimed in claim 2, wherein the control module further comprises a handle member configured for allowing the user to hold and move the control module.

4. The remote control apparatus as claimed in claim 1, wherein the image sensing module comprises a lens module, an image sensor and a filter disposed between the lens module and the image sensor.

5. The remote control apparatus as claimed in claim 4, wherein the light source is an infrared light source, and the filter is an infrared pass filter.

6. A remote control system, comprising:
a light source configured for emitting a light beam in a predetermined wavelength range;
a control module separated from the light source and moveable by the user in the command movement, the control module being configured for receiving the light beam from the light source in an incident direction and reflecting the light beam in a direction anti-parallel to the incident direction;
an image sensing module fixed relative to the light source and configured for sensing an image formed by the reflected light beam;
an image processing module electrically connected with the image sensing module, the image processing module being configured for processing images sensed by the image sensing module and generating a control signal associated with a movement of the control module in three dimensional space imparted by the user; and
a communication module electrically connected with the image processing module, the communication module being configured for outputting the control signal received from the image processing module; and
an information technology system subjected to the control of the control signal from the communication module.

7. The remote control system as claimed in claim 6, wherein the control module comprises one of an isosceles right triangular prism, a mirror assembly and a cat's eye reflector.

8. The remote control system as claimed in claim 7, wherein the control module further comprises a handle member configured for allowing the user to hold the control module.

9. The remote control system as claimed in claim 6, wherein the image sensing module comprises a lens module, an image sensor and a filter disposed between the lens module and the image sensor.

10. The remote control system as claimed in claim 9, wherein the light source is an infrared light source and the filter is an infrared pass filter.

11. A remote control system for remotely controlling movement of an object displayed on a display screen, comprising:
a light source for emitting a light beam;
an image sensor fixed relative to the light source;
a wireless control module spaced from the light source, the control module being configured for receiving the light beam from the light source and reflecting the light beam to the image sensor, the image sensor being arranged for capturing an image of the reflected light beam from the wireless control module;
an image processing module electronically coupled to the image sensor, the image processing module being arranged for analyzing the image of the reflected light beam from the wireless control module to determine a movement of the wireless control module imparted by a user, and generating a control signal associated with the movement of the wireless control module; and
a processing unit for controlling the movement of the object displayed on the display screen according to the control signal.
